(19) United States
(12) Patent Application Publication
(10) Pub. No.: US 2009/0223836 A1
(43) Pub. Date: Sep. 10, 2009

(54) Frequency Technique for Electrochemical Sensors

(76) Inventors: Leta Yar-Li Woo, Oakland, CA (US); Robert S. Glass, Livermore, CA (US); Robert F. Novak, Farmington Hills, MI (US); Jacobus Hendrick Visser, Farmington Hills, MI (US); Erica Perry Murray, Barrington, IL (US); Louis Peter Martin, San Ramon, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/427,194

(22) Filed: Apr. 21, 2009

Related U.S. Application Data
(63) Continuation-in-part of application No. 11/893,751, filed on Aug. 16, 2007.
(60) Provisional application No. 61/138,735, filed on Dec. 18, 2008.

(51) Int. Cl. G01N 27/26

(52) U.S. Cl. 205/785.5; 204/424

(57) ABSTRACT

An electrochemical sensor system for monitoring emissions includes locating first and second electrodes in a position to sense the emissions. At least one of the first and second electrodes is made of a dense electrode material. An ion-conductor material that acts as an electrolyte is operatively connected to the first and second electrodes. The first electrode is excited at a frequency f₁, A response is received from the first electrode at frequency f₁. A second signal is received base on the emissions and a response is produced indicating the emissions.

### CROSS-REFERENCE TO RELATED APPLICATIONS

This application claims the benefit of U.S. Provisional Patent Application No. 61/138,735 filed Dec. 18, 2008 and titled “Frequency Technique for Operating Electrochemical Sensors” which is incorporated herein by this reference.

This application is a Continuation-in-Part of U.S. patent application Ser. No. 11/893,751 filed Aug. 16, 2006 and titled “Multiple Frequency Method for Operating Electrochemical Sensors” which is incorporated herein by this reference.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### BACKGROUND

1. Field of Endeavor

The present invention relates to electrochemical sensors and more particularly to a multiple frequency method for operating electrochemical sensors.

2. State of Technology

The article, “Impedancemetric NOx Sensing Using YSZ Electrolyte and YSZ/Cr2O3 Composite Electrodes,” by L. Peter Martin, Leta Y. Woo, and Robert S. Glass, in Journal of The Electrochemical Society, 154 (3) J97-J104 (2007), provides the following state of technology information, “Increasingly stringent emissions regulations require the development of advanced gas sensors for a variety of applications. For example, compact, inexpensive sensors are needed for detection of regulated pollutants, including hydrocarbons (HC), CO, and NOx, in automotive exhaust. Because many emerging applications, particularly monitoring of automotive exhaust, involve operation in harsh environments, which can include high temperature and corrosive or chemically reactive conditions, ceramic oxide-based electrochemical sensors have received considerable interest.” The article, “Impedancemetric NOx Sensing Using YSZ Electrolyte and YSZ/Cr2O3 Composite Electrodes,” is incorporated in this application in its entirety for all purposes. Additional information about the sensor systems is provided in the following four articles: (1) “Effect of electrode composition and microstructure on impedancemetric nitric oxide sensors based on YSZ electrolyte,” by L. Y. Woo, L. P. Martin, R. S. Glass, W. Wang, S. Jung, R. J. Gorte, E. P. Murray, R. F. Novak, and J. H. Visser, in J. Electrochem. Soc., 155(1):J32-40, (2008); (2) “Impedance characterization of a model Au/yttria-stabilized zirconia/Au electrochemical cell in varying oxygen and NOx concentrations,” by L. Y. Woo, L. P. Martin, R. S. Glass, and R. J. Gorte, in J. Electrochem. Soc., 154(4):J129-135 (2007); (3) “Development of NOx Sensing Devices Based on YSZ and Oxide Electrode Aiming for Monitoring Car Exhausts,” by N. Miura, M. Nakatou, S. Zhuiykov, Ceramics International, 30, pp. 1135-1139 (2004); and (4) “Impedancemetric gas sensor based on zirconia solid electrolyte and oxide sensing electrode for detecting total NOx at high temperature,” by N. Miura, M. Nakatou, and S. Zhuiykov, in Sensors and Actuators B, 93:221-228 (2003). The four articles are incorporated in this application in their entirety for all purposes.

U.S. Pat. No. 6,551,149 issued Apr. 23, 2003 to Yunzhi Gao et al for measuring NOx concentration provides the following state of technology information: “Emissions of NOx from internal combustion engines used mainly in automotive vehicles and from the combustion equipment of thermal power stations and plants are a cause of photochemical smog and acid rain, are harmful to the human respiratory system and represent a major source of global environmental pollution. For these reasons the detection of noxious gases such as NOx is a major concern and a gas sensor that contributes to a reduction in the size and cost of measurement equipment and that is usable in a variety of environments has been sought. In recent years much attention has been focused on all solid-state NOx sensors inserted directly into the exhaust gas of an automotive vehicle to sense the gases continuously, and results of related research have been reported.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides an electrochemical sensor system for monitoring emissions that includes locating first and second electrodes in a position to sense the emissions. At least one of the first and second electrodes is made of a dense electrode material. An ion-conductor material that acts as an electrolyte is operatively connected to the first and second electrodes. The first electrode is excited at a frequency f₁, A response is received from the first electrode at frequency f₁. A second signal is received base on the emissions and a response is produced indicating the emissions.

The present invention provides a multiple frequency method for the operation of a sensor. The present invention is a multiple frequency method for the operation of a sensor to measure a parameter of interest using calibration information wherein interfering parameters may be present. The method includes the steps of exciting the sensor at a first frequency providing a first sensor response, exciting the sensor at a second frequency providing a second sensor response, using the second sensor response at the second frequency and the calibration information to produce a calculated concentration of the interfering parameters, using the first sensor response at the first frequency, the calculated concentration of the interfering parameters, and the calibration information to measure the parameter of interest. The method has advantages over more traditional potentiometric (open circuit) or amperometric (dc-biased) sensors.

In one embodiment the present invention utilizes an alternating current (ac) signal across the electrodes of an electrochemical cell, and measurement of the impedance characteristics associated with the cell at the frequency of the ac signal, in particular the phase difference between the excitation signal and the sensor response at the excitation frequency. Multiple frequencies may be used, simultaneously or sequentially, to provide real-time compensation for aging, interfering species, and environmental variations (i.e., temperature). Another embodiment of the present invention is focused on sensing NOx gas in high temperature automotive exhaust gas using a solid state cell composed of a ceramic electrolyte and electrodes.

The present invention is not specific to any particular electrolyte or electrode materials, or to any particular species being sensed. The sensing methodology should be broadly applicable to the use of electrochemical cells for detecting species of interest. It does appear that the physical mechanisms resulting in the sensor response to the analyte of interest and to any interfering species or effect must be sufficiently different as to cause them to have different frequency dependencies.

The present invention has many uses. For example, the present invention can be used for the detection of pollutant gasses in a hot, flowing gas stream. Applications include the monitoring of industrial exhaust gasses and vehicle emissions. Broader applications include any application where electrochemical sensors are of interest.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of the multiple frequency method for the operation of a sensor of the present invention.

FIG. 2 shows additional details of steps of the multiple frequency method for the operation of a sensor of the present invention.

FIG. 3 shows additional details of steps of the multiple frequency method for the operation of a sensor of the present invention.

FIG. 4 illustrates the final step of the multiple frequency method for the operation of a sensor of the present invention.

FIG. 5 illustrates another embodiment of the multiple frequency method for the operation of a sensor of the present invention to detect NO in a varying O₂ background.

FIG. 6 illustrates an alternate embodiment of the invention where frequencies f₁ and f₂ are excited simultaneously.

FIG. 7 illustrates schematically the process of determining the NO concentration by using the multiple frequency technique to correct for an unknown O₂ concentration.

FIG. 8 illustrates another embodiment of the multiple frequency method for the operation of a sensor of the present invention to detect CO in a varying O₂ background.

FIG. 9 illustrates yet another embodiment of the multiple frequency method for the operation of a sensor of the present invention to detect NO in a varying temperature environment.

FIG. 10 illustrates the operation of a H₂ sensor trying to measure the concentration of H₂ in a background with varying H₂O concentration.

FIG. 11 illustrates the operation of a NO₂ sensor trying to measure the concentration of NO₂ in a background with varying O₂ concentration.

FIG. 12 illustrates a sensing method for measuring NO in a background with varying O₂ concentration.

FIG. 13 illustrates a sensing method for measuring CO in a background with varying O₂ concentration.

FIG. 14 illustrates a sensing method for measuring NO in a background with varying temperature.

FIG. 15 illustrates a sensing method for measuring NO₂ in a background with varying O₂ concentration.

FIG. 16 illustrates an embodiment of a sensor system for monitoring emissions.

FIG. 17 illustrates operation of the sensor system for monitoring emissions.

FIG. 18 illustrates another embodiment of a sensor system for monitoring emissions.

FIG. 19 illustrates yet another embodiment of a sensor system for monitoring emissions.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

The present invention provides a mode of operation of sensors, particularly electrochemical sensors. The method includes the steps of exciting the sensor at a first frequency providing a first sensor response, exciting the sensor at a second frequency providing a second sensor response, using the second sensor response at the second frequency and the calibration information to produce a calculated concentration of the interfering parameters, using the first sensor response at the first frequency, the calculated concentration of the interfering parameters, and the calibration information to measure the parameter of interest. Additional information about the present invention is included in the article, “Impedancemetric NOx Sensing Using YSZ Electrolyte and YSZ/Cr2O3 Composite Electrodes,” by L. Peter Martin, Leta Y. Woo, and Robert S. Glass, in Journal of The Electrochemical Society, 154 (3) J97-J104 (2007). The article, “Impedancemetric NOx Sensing Using YSZ Electrolyte and YSZ/Cr2O3 Composite Electrodes,” by L. Peter Martin, Leta Y. Woo, and Robert S. Glass, in Journal of The Electrochemical Society, 154 (3) J97-J104 (2007) is incorporated in this application by this reference.

One embodiment of the present invention provides solid (ceramic oxide based) sensors for detection of small concentrations (ppm levels) of pollutant gasses in automotive exhaust. However, it is to be understood that applications for the invention may be significantly broader, and this application is not limited to gas sensors, or solid oxide sensors.

Another embodiment of the present invention provides an electrochemical cell consisting of an electrolyte and two (or possibly more) electrodes. The sensor is operated by applying an excitation signal which consists of a varying (typically sinusoidal) voltage difference between the two electrodes. The excitation signal consists of a fixed frequency, for example 10 Hz. A phase meter, phase lock loop, or other electronic measuring circuit is used to measure the changes in amplitude and phase of the excitation signal, after it interacts with the sensor, relative to a fixed, reference signal of the same frequency. The sensor response, which can be correlated with the impedance |Z| or the phase, is sensitive to the changes which the sensor is trying to detect (for example the NOₓ concentration in an exhaust gas) as well as to changes in some interfering species or effect (O₂ or temperature). To correct for the uncertainty introduced by the unknown effect of the interference on the sensor response, the sensor is excited at a second frequency, for example 1000 Hz, where the response is only sensitive to the interfering species or effect. Comparison of the two responses, in conjunction with the appropriate calibration information, allows calculation of the concentration of the species of interest (i.e., NO) and of the interfering species.

One aspect of the present invention is the operation at non-zero (ac) frequency. Electrochemical gas sensors are traditionally operated either passively (no excitation at all) or using a zero-frequency (dc) excitation. Operating at non-zero frequency provides several advantages over the traditional dc modes of operation. There is more ‘information’ in the ac response because it is, by definition, a dynamic (non-steady state) response and therefore contains not only amplitude information, but also some measure of the time-dependence of the response. Also, the frequency determines response and sampling times (with 1/frequency representing a general limitation for the sampling rate). Thus, it is desirable to operate at the highest frequency at which sufficient sensitivity can be obtained. Additionally, the sensor response to different species (say O₂ and NO) often can be distinguished by virtue of the differences in the frequency dependence of the responses to the different species. This is not possible using the traditional dc approach. This provides a third point of novelty of the proposed sensor . . . that the sensor can be simultaneously operated at two (or more) widely different frequencies to provide a compensation for these interfering effects. That is, for example, at 10 Hz the sensor senses both changes in the concentrations of NOx and O2, while at 1000 Hz it senses only the changes in O₂. Thus, by comparing these signals the competing effects of variations of several percent in the O₂ background can be deconvolved from the effects of ppm changes in the NOₓ concentration.

One embodiment of the present invention includes the use of an ac excitation for the sensor at frequencies above ˜1 Hz. In particular, the use of the phase response of the sensor as the metric which is correlated with the gas composition. Another embodiment of the present invention includes the use of multiple frequencies to compensate for interfering gasses and or environmental variations. As an example, the target application of the ongoing project is to detect 2-25 ppm NO in a background of 5-20% O₂. At low frequencies, <40 Hz, the sensors we have fabricated are sensitive to both the NO and O₂ concentrations. However, at higher frequencies, >500 Hz, the sensor is only sensitive to O₂. By measuring at both frequencies, we can compensate the effect of large variations (several %) in the oxygen concentration in a way that allows us to clearly resolve changes in the NO concentrations on the ppm level.

### Method for the Operation of a Sensor

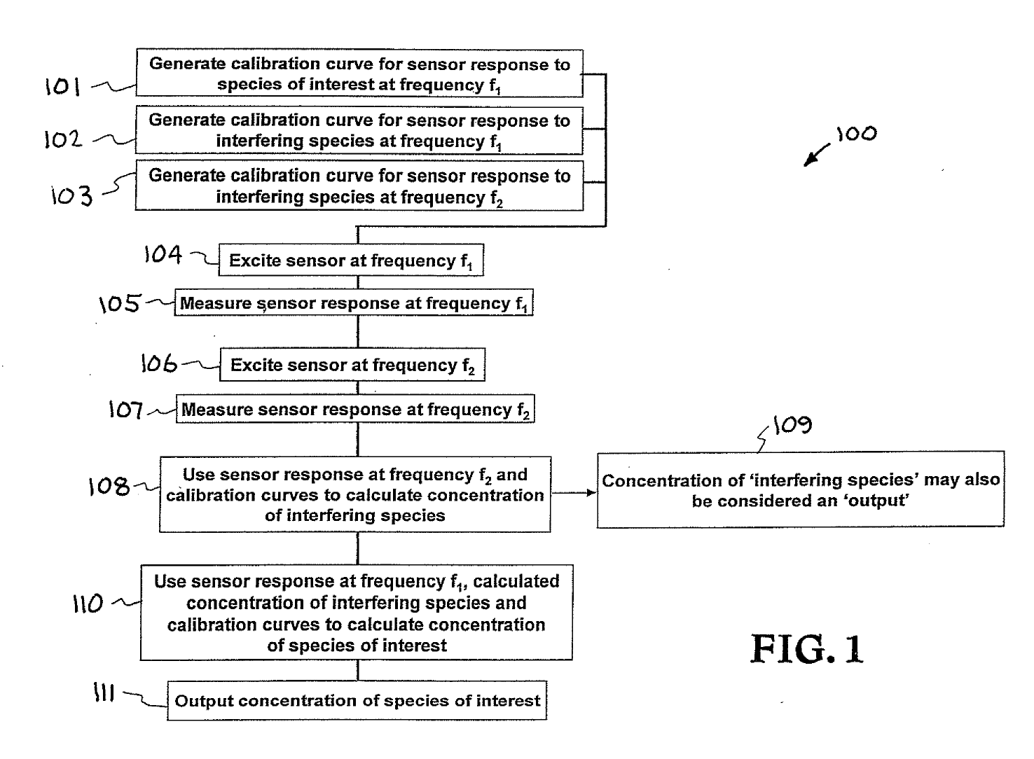

Referring now to the drawings and in particular to FIG. 1, an embodiment of the multiple frequency method for the operation of a sensor of the present invention is illustrated. This embodiment of the multiple frequency method for the operation of a sensor of the present invention is designated generally by the reference numeral 100. The method 100 is a multiple frequency method for the operation of a sensor to measure a parameter of interest using calibration information, wherein interfering parameters may be present. The method 100 includes the steps of exciting the sensor at a first frequency providing a first sensor response, exciting the sensor at a second frequency providing a second sensor response, using the second sensor response at the second frequency and the calibration information to produce a calculated concentration of the interfering parameters, using the first sensor response at the first frequency, the calculated concentration of the interfering parameters, and the calibration information to measure the parameter of interest.

The method 100 is an embodiment of the multiple frequency method for the operation of a general sensor trying to measure 1 species of interest with correction for 1 interfering species. The actual sensing element is designed so that the relative sensitivities to the two species are different at two different frequencies—f₁ and f₂. Step 101 is to generate a calibration curve for sensor response to species of interest at frequency f₁. Step 102 is to generate a calibration curve for sensor response to interfering species at frequency f₁. Step 103 is to generate a calibration curve for sensor response to interfering species at frequency f₂. Steps 101, 102, and 103 are performed once, prior to sensor operation.

Step 104 is to excite the sensor at frequency f₁. Response at f₁ contains contributions from both species of interest and interfering species. Step 105 is to measure sensor response at frequency f₁. Step 106 is to excite the sensor at frequency f₂. Step 107 is to measure sensor response at frequency f₂. Response at f₂ contains contributions only from interfering species.

Step 108 is to use sensor response at frequency f₂ and calibration curves to calculate concentration of interfering species. In Step 109 concentration of ‘interfering species’ may also be considered an ‘output.’

Step 110 is to use sensor response at frequency f₁, calculated concentration of interfering species and calibration curves to calculate concentration of species of interest. Step 111 provides output concentration of species of interest.

The method 100 illustrated in FIG. 1 is a computer implemented multiple frequency method for the operation of a sensor to measure a parameter of interest using calibration curves, wherein interfering parameters may be present. The method 100 illustrated in FIG. 1 includes the step 104 of exciting the sensor at a first frequency providing a first sensor response recorded on a computer-readable medium, the step 106 exciting the sensor at a second frequency providing a second sensor response recorded on a computer-readable medium, the step 108 using said second sensor response at said second frequency and the calibration information to produce a calculated concentration of the interfering parameters recorded on a computer-readable medium, and the step 110 using said first sensor response at said first frequency, said calculated concentration of the interfering parameters, and the calibration information to measure the parameter of interest.

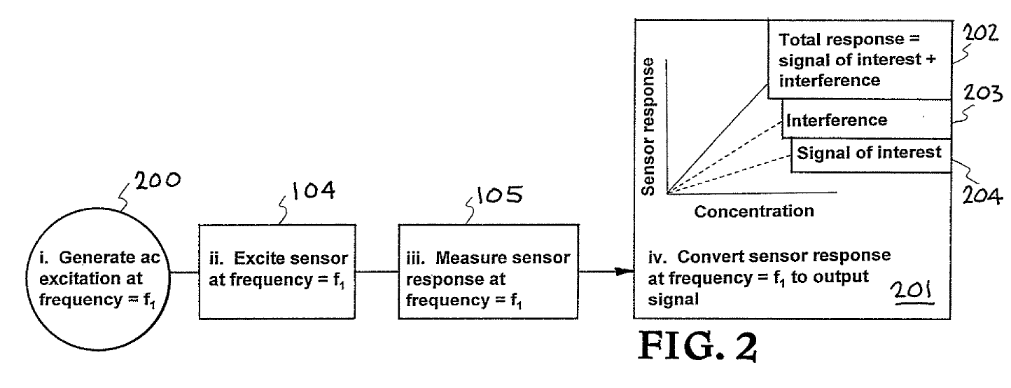

Referring now to FIG. 2, additional details of Steps 104 and 105 are illustrated. The method 100 includes the step 104 of exciting the sensor at a first frequency providing a first sensor response recorded on a computer-readable medium and step 105 of measure sensor response at frequency f₁ and recorded it on a computer-readable medium. Step 104 is to excite the sensor at frequency f₁. This is accomplished by the step 200 generate ac excitation at frequency=f₁. Step 105 is to measure sensor response at frequency f₁. Step 201 includes convert sensor response at frequency=f₁ to output signal. This is illustrated by the plot of “Sensor Response” vs. “Concentration.” This produces the lines 202 “Total response =signal of interest+interference,” the line 203 “Interference,” and line 204 “Signal of interest.” Response is strong, but sensitivity to interference is high. Interference could come from any source that affects sensor output (concentration of other gasses, temperature, etc.).

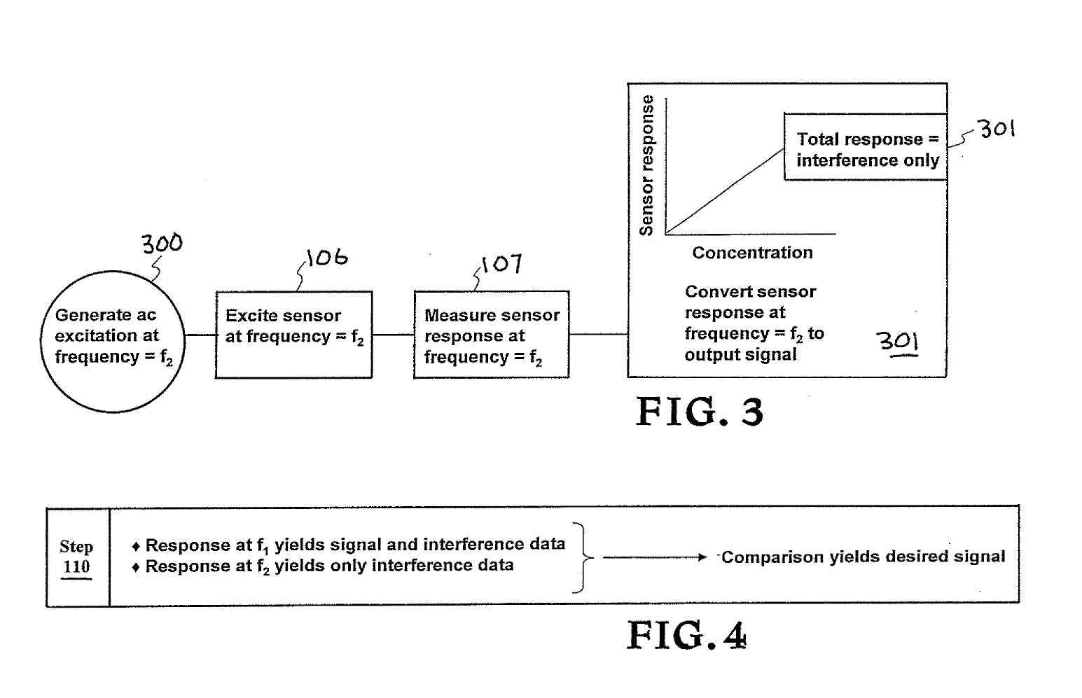

Referring now to FIG. 3, additional details of Steps 106 and 107 are illustrated. Step 106 is to excite the sensor at frequency f₂. This includes step 300 generate ac excitation at frequency=f₂. Step 107 is to measure sensor response at frequency f₂. Response is negligible, but sensitivity to interference is still high. Response at f₂ contains contributions only from interfering species. The method 100 includes the step 106 exciting the sensor at a second frequency providing a second sensor response recorded on a computer-readable medium. Step 107 is to measure sensor response at frequency f₂ and record it on a computer-readable medium. This includes step 301 convert sensor response at frequency=f₂ to output signal. This is illustrated by the plot of “Sensor Response” vs. “Concentration.” This produces the line 301 “Total response interference only.”

Referring now to FIG. 4, the final step of using the first sensor response at the first frequency, the calculated concentration of the interfering parameters, and the calibration information to measure the parameter of interest is illustrated. This step is to calculate signal of interest from the responses at the two frequencies. The response at f₁ yields signal and interference data and the response at f₂ yields only interference data. A comparison yields the desired signal.

### Method for the Operation of a NO Sensor in a Background of Varying O₂

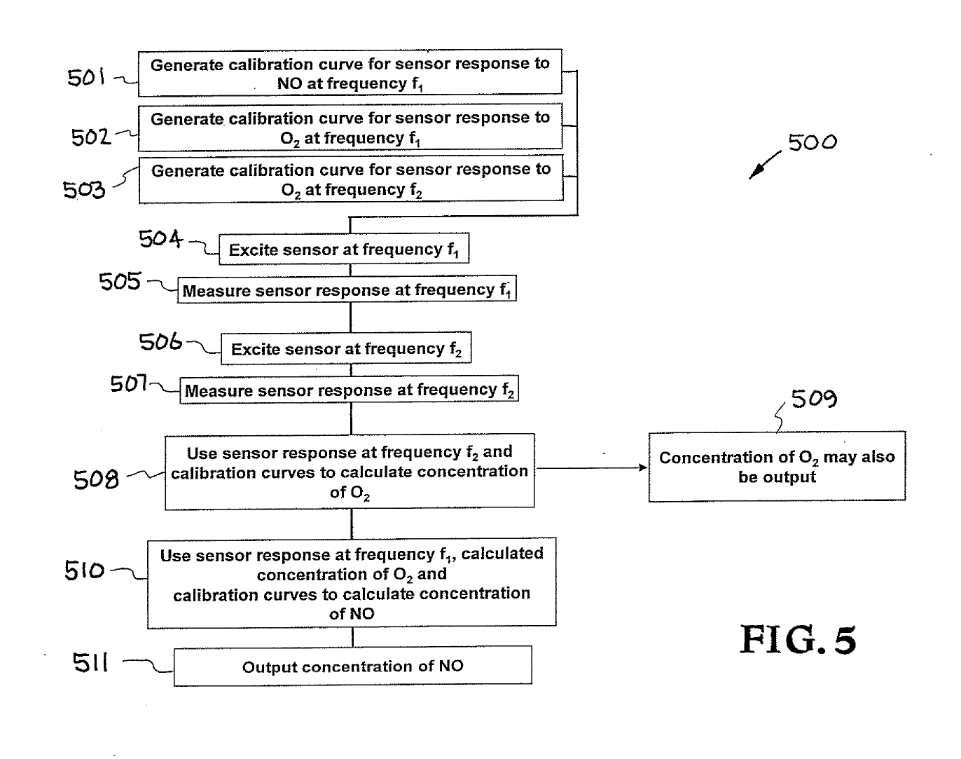

Referring now to the drawings and in particular to FIG. 5, an embodiment of the multiple frequency method for the operation of a NO sensor of the present invention trying to measure the concentration of NO in a background with varying O₂ concentration is illustrated. The actual sensing element must be designed so that the relative sensitivities to NO and O₂ are different at two different frequencies—f₁ and f₂. This embodiment of the multiple frequency method for the operation of a NO sensor of the present invention is designated generally by the reference numeral 500. The method 500 is a multiple frequency method for the operation of a NO sensor to measure a parameter of interest using calibration information, wherein interfering Varying O₂ may be present.

The method 500 includes the steps of exciting the NO sensor at a first frequency providing a first NO sensor response to both NO and O₂, exciting the NO sensor at a second frequency providing a second sensor response to only O₂, using the second sensor response at the second frequency and the calibration information to produce a calculated concentration of O₂, using the first NO sensor response at the first frequency, the calculated concentration of O₂, and the calibration information to calculate the NO concentration.

The method 500 is an embodiment of the multiple frequency method for the operation of a NO sensor trying to measure the concentration of NO in a background with varying O₂ concentration. The actual sensing element must be designed so that the relative sensitivities to NO and O₂ are different at two different frequencies—f₁ and f₂. Step 501 is to generate a calibration curve for sensor response to NO at frequency f₁. Step 502 is to generate a calibration curve for sensor response to O₂ at frequency f₁. Step 503 is to generate a calibration curve for sensor response to O₂ at frequency f₂. Steps 501, 502, and 503 are performed once, prior to NO sensor operation a (i.e., prior to placing the sensor ‘in service’).

Step 504 is to excite the NO sensor at frequency f₁. Response at f₁ contains contributions from both species of interest and interfering species (NO and O₂). Step 505 is to measure NO sensor response at frequency f₁. Step 506 is to excite the NO sensor at frequency f₂. Step 507 is to measure NO sensor response at frequency f₂. Response at f₂ contains contributions only from the interfering species O₂.

Step 508 is to use NO sensor response at frequency f₂ and calibration curves to calculate concentration of interfering species O₂. In Step 509 concentration of ‘interfering species O₂’ may also be considered an ‘output.’

Step 510 is to use NO sensor response at frequency f₁, calculated concentration of interfering species O₂ and calibration curves to calculate concentration of species of interest NO. Step 511 provides output concentration of species of interest NO.

The method 500 illustrated in FIG. 5 is a computer implemented multiple frequency method for the operation of a NO sensor to measure a parameter of interest using calibration curves, wherein interfering parameters may be present. The method 500 illustrated in FIG. 5 includes the step 504 of exciting the NO sensor at a first frequency providing a first NO sensor response from both species of interest and interfering species (NO and O₂) recorded on a computer-readable medium, the step 506 exciting the NO sensor at a second frequency providing a second NO sensor response to O₂ recorded on a computer-readable medium, the step 508 using said second NO sensor response at said second frequency for the interfering species (O₂) and the calibration information to produce a calculated concentration of the interfering parameter O₂ recorded on a computer-readable medium, and the step 510 using said first NO sensor response at said first frequency, said calculated concentration of the interfering parameters O₂, and the calibration information to calculate the parameter of interest NO.

### Example—NO Sensor in a Background of Varying O₂

An example of the multiple frequency method for the operation of a NO sensor of the present invention trying to measure the concentration of NO in a background with varying O₂ concentration is provided to further explain the principles of the invention. As illustrated in FIG. 5, a calibration curve for sensor response to NO at frequency f₁ is produced to provide calibration information. A calibration curve for sensor response to O₂ at frequency f₁ is produced to provide calibration information. A calibration curve for sensor response to O₂ at frequency f₂ is produced to provide calibration information.

In Step 504 the NO sensor was excited at frequency f₁ of 10 Hz. The response at f₁ contains contributions from both NO and O₂.

In Step 505 the NO sensor phase response at frequency f₁ was measured as −40.5 degrees.

In Step 506 the NO sensor was excited at frequency f₂ of 1000 Hz.

In Step 507 the NO sensor response at frequency f₂ was measured as −32.3 degrees. Response at f₂ contains contributions only from O₂.

In Step 508 the NO sensor response at frequency f₂ and calibration curves were used to calculate concentration of interfering species O₂ as 7.0%.

In Step 510 the NO sensor response at frequency f₁, calculated concentration of interfering species O₂, and calibration curves were used to calculate concentration of species of interest NO as 15 ppm.

The concentration of species of interest NO 15 ppm is the output as shown in Step 511.

Note: in Step 509 the concentration of “interfering species O₂ 7.0%” may also be considered an “output.”

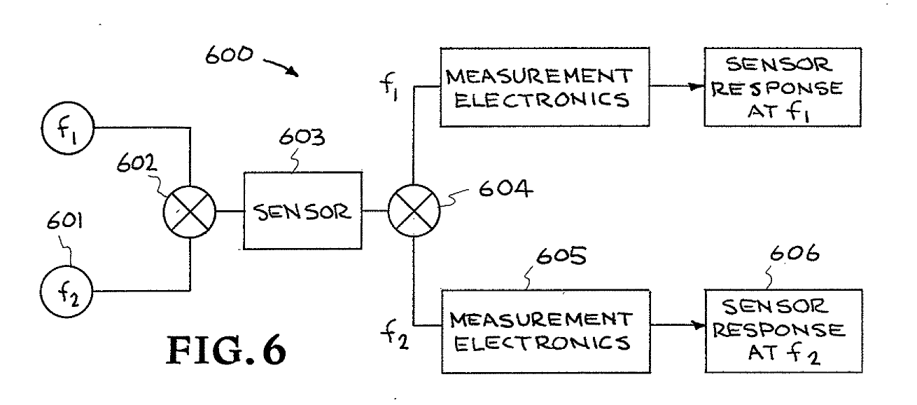

Referring now to FIG. 6, an alternate embodiment of the invention is illustrated wherein frequencies f₁ and f₂ are excited simultaneously. The alternate embodiment is designated generally the reference numeral 600. The method 600 includes the following steps. In step 601 excitation signals at frequencies f₁ and f₂ are generated. In step 602, the excitation signals are electronically mixed (added) together to produce a single excitation signal with two frequency components at f₁ and f₂. In step 603 the sensor is excited by the combined signal. In step 604, the sensor response is electronically separated into the frequency components at f₁ and f₂. In step 605, measurement electronics are used to measure the sensor response at f₁ and f₂. These responses are then passed (step 606) to a computer for further analysis.

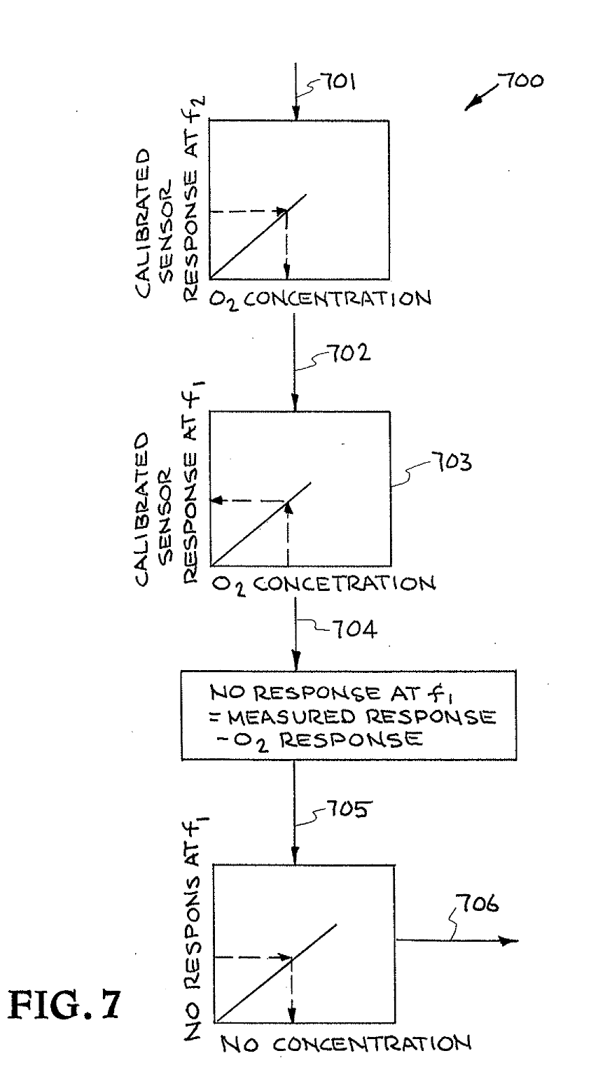

Referring now to FIG. 7, the process of determining the NO concentration by using the multiple frequency technique to correct for an unknown O₂ concentration is illustrated. The process is designated generally by the reference numeral 700. Note that in this example the sensor has been configured so that the response at f₁ is sensitive to both NO and O₂ concentrations, while the response at f₂ is sensitive only to the O₂ concentration. The process 700 begins with the measured sensor response at f₁ and f₂. These responses may be measured via simultaneous excitation at the two frequencies, as described in FIG. 6, or via consecutive excitations at each frequency (i.e., f₁ then f₂). The process of determining the NO concentration in FIG. 7 consists of the following steps. In step 701 the measured sensor response at f₂ is read from the computer. In step 702, a predetermined calibration curve is used to determine the O₂ concentration from the measured sensor response at f₂. In step 703 the O₂ concentration determined from the f₂ response is used to predict the portion of the sensor response at fl that corresponds only to the contribution of the O₂ concentration. This is accomplished using a 2^{nd}, predetermined calibration curve. In step 704 the portion of the sensor response at f₁ due to the NO concentration is determined from the total measured response and the O₂ response calculated in step 703. In step 705 a 3^{rd} predetermined calibration curve is used to determine the NO concentration from the NO response determined in step 704. Finally, in step 706 the NO concentration is output from the measurement system.

### Method for the Operation of a CO Sensor in a Background Varying O₂

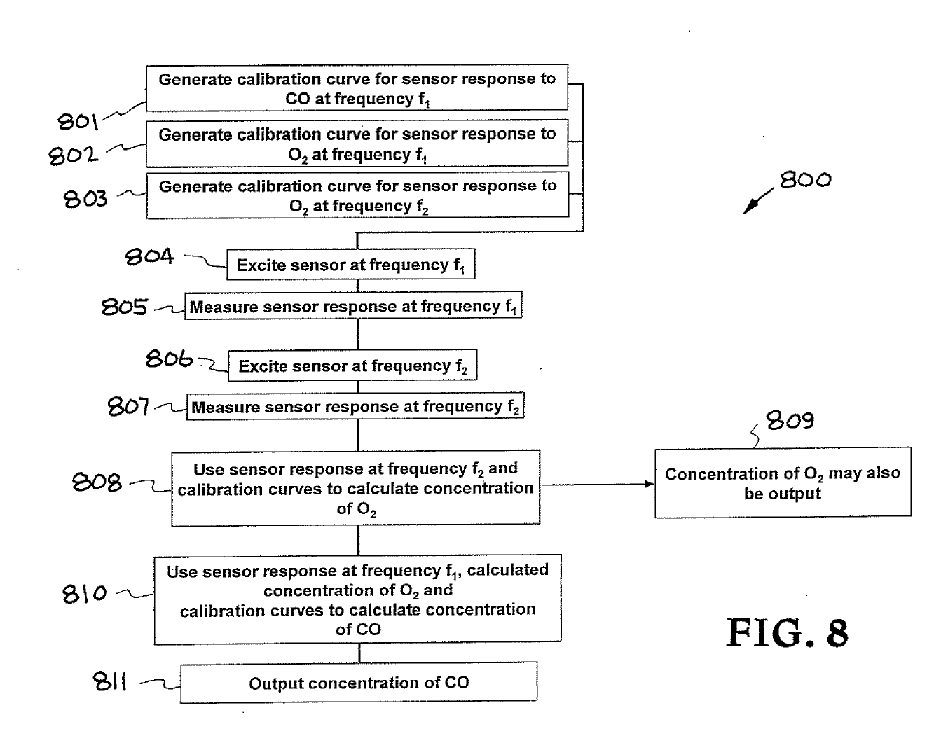

Referring now to the drawings and in particular to FIG. 8, an embodiment of the multiple frequency method for the operation of a CO sensor of the present invention trying to measure the concentration of CO in a background with varying O₂ concentration is illustrated. The actual sensing element must be designed so that the relative sensitivities to CO and O₂ are different at two different frequencies—f₁ and f₂. This embodiment of the multiple frequency method for the operation of a CO sensor of the present invention is designated generally by the reference numeral 800. The method 800 is a multiple frequency method for the operation of a CO sensor to measure a parameter of interest using calibration information, wherein interfering varying O₂ may be present.

The method 800 includes the steps of exciting the CO sensor at a first frequency providing a first CO sensor response at f₁ that contains contributions from both CO and O₂, exciting the CO sensor at a second frequency providing a second sensor response at f₂ that contains contributions only from O₂, using the first sensor response of both CO and O₂ at f₁ and the calibration information to produce a calculated concentration of O₂, using the first CO sensor response at the first frequency, the calculated concentration of O₂, and the calibration information to measure CO.

Step 801 is to generate a calibration curve for sensor response to CO at frequency f₁. Step 802 is to generate a calibration curve for sensor response to O₂ at frequency f₁. Step 803 is to generate a calibration curve for sensor response to O₂ at frequency f₂. Steps 801, 802, and 803 are performed once, prior to CO sensor operation.

Step 804 is to excite the CO sensor at frequency f₁. Response at f₁ contains contributions from both CO and O₂. Step 805 is to measure CO sensor response at frequency f₁. Step 806 is to excite the CO sensor at frequency f₂.

Step 807 is to measure CO sensor response at frequency f₂. Response at f₂ contains contributions only from O₂. Step 808 is to use CO sensor response at frequency f₂ and calibration curves to calculate concentration of O₂. In Step 809 concentration of ‘O₂’ may be considered an ‘output.’

Step 810 is to use CO sensor response at frequency f₁, calculated concentration of O₂ and calibration information to calculate concentration of CO. Step 811 provides output concentration of species of interest CO.

The method 800 illustrated in FIG. 8 is a computer implemented multiple frequency method for the operation of a CO sensor to measure a parameter of interest using calibration curves, wherein interfering parameters may be present. The method 800 illustrated in FIG. 8 includes the step 804 of exciting the CO sensor at a first frequency providing a first CO sensor response from both species of interest and interfering species (CO and O₂) recorded on a computer-readable medium, the step 806 exciting the CO sensor at a second frequency providing a second CO sensor response recorded on a computer-readable medium, the step 808 using said second CO sensor response at said second frequency from both species of interest and interfering species (CO and O₂) and the calibration information to produce a calculated concentration of the interfering parameters O₂ recorded on a computer-readable medium, and the step 810 using said first CO sensor response at said first frequency, said calculated concentration of the interfering parameters O₂, and the calibration information to measure the parameter of interest CO.

### Method for the Operation of a NO Sensor with Uncertain Temperature

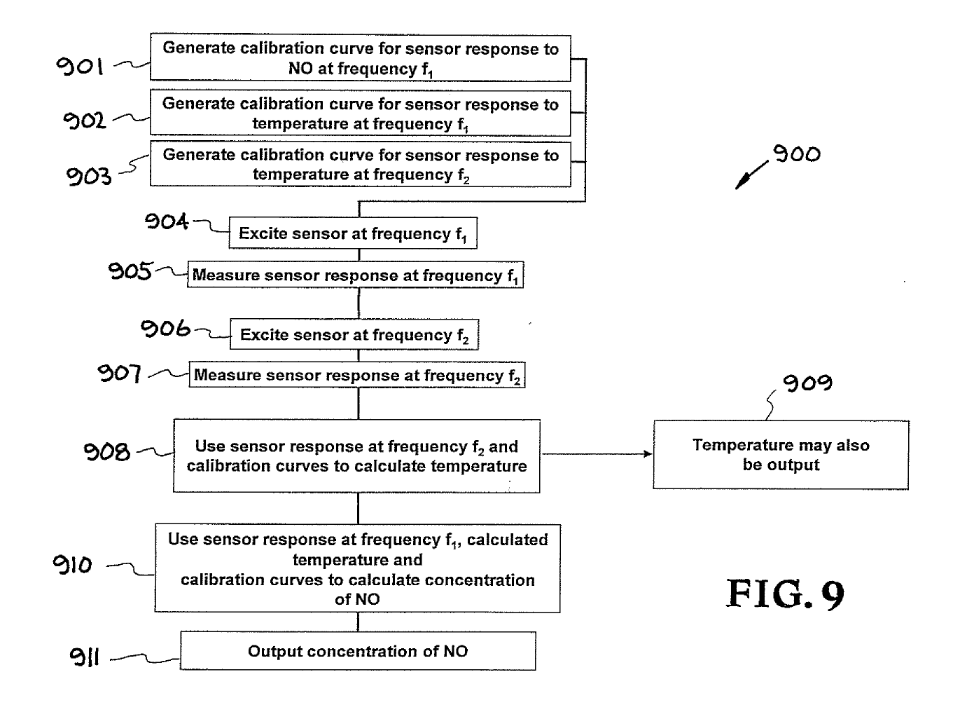

Referring now to the drawings and in particular to FIG. 9, an embodiment of the multiple frequency method for the operation of a NO sensor of the present invention trying to measure the concentration of NO where the temperature is uncertain is illustrated. The actual sensing element must be designed so that the relative sensitivities to NO and temperature are different at two different frequencies—f₁ and f₂. This embodiment of the multiple frequency method for the operation of a NO sensor of the present invention is designated generally by the reference numeral 900. The method 900 is a multiple frequency method for the operation of a NO sensor to measure a parameter of interest using calibration information, wherein interfering varying temperature may occur.

The method 900 includes the steps of exciting the NO sensor at a first frequency providing a first NO sensor response at f₁ that contains contributions from both NO and temperature, exciting the NO sensor at a second frequency providing a second sensor response at f₂ that contains contributions only from temperature, using the first sensor response of both NO and temperature at f₁ and the calibration information to produce a calculated temperature, using the first NO sensor response at the first frequency, the calculated temperature, and the calibration information to measure NO.

The method 900 is an embodiment of the multiple frequency method for the operation of a NO sensor trying to measure the concentration of NO with uncertain temperature. The actual sensing element must be designed so that the relative sensitivities to NO and temperature are different at two different frequencies—f₁ and f₂. Step 901 is to generate a calibration curve for sensor response to NO at frequency f₁. Step 902 is to generate a calibration curve for sensor response to temperature at frequency f₁. Step 903 is to generate a calibration curve for sensor response to temperature at frequency f₂. Steps 901, 902, and 903 are performed once, prior to NO sensor operation.

Step 904 is to excite the NO sensor at frequency f₁. Response at f₁ contains contributions from both NO and temperature. Step 905 is to measure NO sensor response at frequency f₁. Step 906 is to excite the NO sensor at frequency f₂.

Step 907 is to measure NO sensor response at frequency f₂. Response at f₂ contains contributions only from temperature

Step 908 is to use NO sensor response at frequency f₂ and calibration curves to calculate temperature. In Step 909 “temperature” may be considered an “output.”

Step 910 is to use NO sensor response at frequency f₁, calculated temperature and calibration information to calculate concentration of NO. Step 911 provides output concentration of species of interest NO.

The method 900 illustrated in FIG. 9 is a computer implemented multiple frequency method for the operation of a NO sensor to measure a parameter of interest using calibration curves, wherein interfering parameters may be present. The method 900 illustrated in FIG. 9 includes the step 904 of exciting the NO sensor at a first frequency providing a first NO sensor response from both species of interest and interfering species (NO and temperature) recorded on a computer-readable medium, the step 906 exciting the NO sensor at a second frequency providing a second NO sensor response recorded on a computer-readable medium, the step 908 using said second NO sensor response at said second frequency from both species of interest and interfering species (NO and temperature) and the calibration information to produce a calculated temperature recorded on a computer-readable medium, and the step 910 using said first NO sensor response at said first frequency, said calculated temperature, and the calibration information to measure the parameter of interest NO.

### Method for the Operation of a H₂ Sensor in a Background Varying H₂O

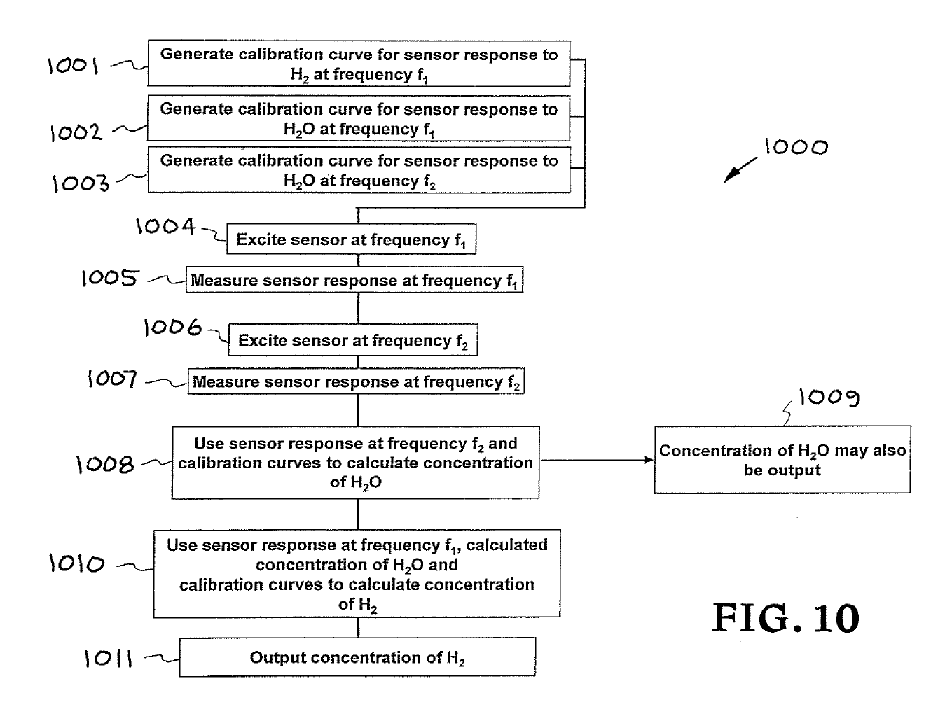

Referring now to the drawings and in particular to FIG. 10, an embodiment of the multiple frequency method for the operation of a H₂ sensor of the present invention trying to measure the concentration of H₂ in a background with varying H₂O concentration is illustrated. The actual sensing element must be designed so that the relative sensitivities to H₂ and H₂O are different at two different frequencies—f1 and f₂. This embodiment of the multiple frequency method for the operation of a H₂ sensor of the present invention is designated generally by the reference numeral 1000. The method 1000 is a multiple frequency method for the operation of a H₂ sensor to measure the H₂ concentration using calibration information, wherein varying H₂O concentration may interfere with the sensor response.

The method 1000 includes the steps of exciting the H₂ sensor at a first frequency providing a first H₂ sensor response to both H₂ and H₂O concentrations, exciting the H₂ sensor at a second frequency providing a second sensor response to H₂O, using the second sensor response at the second frequency and the calibration information to produce a calculated concentration of H₂O, using the first H₂ sensor response at the first frequency, the calculated concentration of H₂O, and the calibration information to calculate the H² concentration.

The method 1000 is an embodiment of the multiple frequency method for the operation of a H₂ sensor trying to measure the concentration of H₂ in a background with varying H₂O concentration. The actual sensing element must be designed so that the relative sensitivities to H₂ and H₂O are different at two different frequencies—f₁ and f₂. Step 1001 is to generate a calibration curve for sensor response to H₂ at frequency f₁. Step 1002 is to generate a calibration curve for sensor response to H₂O at frequency f₁. Step 1003 is to generate a calibration curve for sensor response to H₂O at frequency f₂. Steps 1001, 1002, and 1003 are performed once, prior to H₂ sensor operation.

Step 1004 is to excite the H₂ sensor at frequency f₁. Response at f₁ contains contributions from both species of interest and interfering species (H₂ and H₂O). Step 1005 is to measure H₂ sensor response at frequency f₁. Step 1006 is to excite the H₂ sensor at frequency f₂. Step 1007 is to measure H₂ sensor response at frequency f₂. Response at f₂ contains contributions only from the interfering species H₂O.

Step 1008 is to use H₂ sensor response at frequency f₂and calibration curves to calculate concentration of interfering species H₂O. In Step 1009 concentration of ‘interfering species H₂O’ may also be considered an ‘output.’

Step 1010 is to use H₂ sensor response at frequency f₁, calculated concentration of interfering species H₂O and calibration curves to calculate concentration of species of interest H₂. Step 1011 provides output concentration of species of interest H₂.

The method 1000 illustrated in FIG. 10 is a computer implemented multiple frequency method for the operation of a H₂ sensor to measure a parameter of interest using calibration curves, wherein interfering parameters may be present. The method 1000 illustrated in FIG. 10 includes the step 1004 of exciting the H₂ sensor at a first frequency providing a first H₂ sensor response from both species of interest and interfering species (H₂ and H₂O) recorded on a computer-readable medium, the step 1006 exciting the H₂ sensor at a second frequency providing a second H₂ sensor response recorded on a computer-readable medium, the step 1008 using said second H₂ sensor response at said second frequency from both species of interest and interfering species (H₂ and H₂O) and the calibration information to produce a calculated concentration of the interfering parameters H₂O recorded on a computer-readable medium, and the step 1010 using said first H₂ sensor response at said first frequency, said calculated concentration of the interfering parameters H₂O, and the calibration information to measure the parameter of interest H₂.

### Method for the Operation of a NO₂ Sensor in a Background Varying O₂

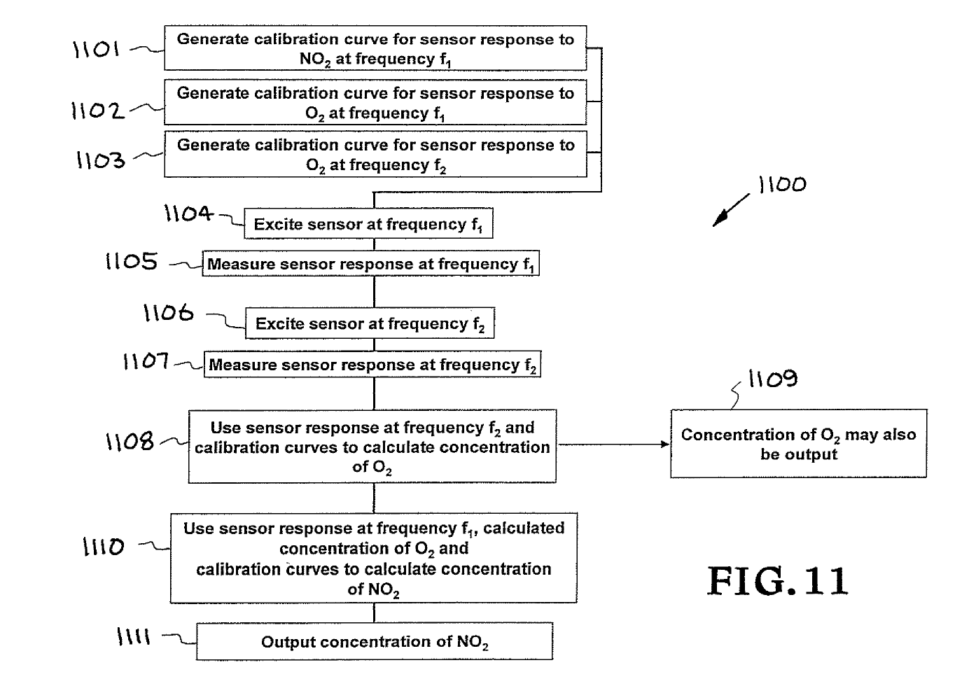

Referring now to the drawings and in particular to FIG. 11, an embodiment of the multiple frequency method for the operation of a NO₂ sensor of the present invention trying to measure the concentration of NO₂ in a background with varying O₂ concentration is illustrated. The actual sensing element must be designed so that the relative sensitivities to NO₂ and O₂ are different at two different frequencies—f₁ and f₂. This embodiment of the multiple frequency method for the operation of a NO₂ sensor of the present invention is designated generally by the reference numeral 1100. The method 1100 is a multiple frequency method for the operation of a NO₂ sensor to measure a parameter of interest using calibration information, wherein interfering varying O₂ concentration may be present.

The method 1100 includes the steps of exciting the NO₂ sensor at a first frequency providing a first NO₂ sensor response sensitive to both NO₂ and O₂, exciting the NO₂ sensor at a second frequency providing a second sensor response to only O₂, using the second sensor response at the second frequency and the calibration information to produce a calculated concentration of O₂, using the first NO₂ sensor response at the first frequency, the calculated concentration of O₂, and the calibration information to calculate the NO₂ concentration.

The method 1100 is an embodiment of the multiple frequency method for the operation of a NO₂ sensor trying to measure the concentration of NO₂ in a background with varying O₂ concentration. The actual sensing element must be designed so that the relative sensitivities to NO₂ and O₂ are different at two different frequencies—f₁ and f₂. Step 1101 is to generate a calibration curve for sensor response to NO₂ at frequency f₁. Step 1102 is to generate a calibration curve for sensor response to O₂ at frequency f₁. Step 1103 is to generate a calibration curve for sensor response to O₂ at frequency f₂. Steps 1101, 1102, and 1103 are performed once, prior to NO₂ sensor operation.

Step 1104 is to excite the NO₂ sensor at frequency f₁. Response at f₁ contains contributions from both species of interest and interfering species (NO₂ and O₂). Step 1105 is to measure NO₂ sensor response at frequency f₁. Step 1106 is to excite the NO₂ sensor at frequency f₂. Step 1107 is to measure NO₂ sensor response at frequency f₂. Response at f₂ contains contributions only from the interfering species O₂.

Step 1108 is to use NO₂ sensor response at frequency f₂and calibration curves to calculate concentration of interfering species O₂. In Step 1109 concentration of ‘interfering species O₂’ may also be considered an ‘output.’

Step 1110 is to use NO₂ sensor response at frequency f₁, calculated concentration of interfering species O₂ and calibration curves to calculate concentration of species of interest NO. Step 1111 provides output concentration of species of interest NO₂.

The method 1100 illustrated in FIG. 11 is a computer implemented multiple frequency method for the operation of a NO₂ sensor to measure a parameter of interest using calibration curves, wherein interfering parameters may be present. The method 1100 illustrated in FIG. 11 includes the step 1104 of exciting the NO₂ sensor at a first frequency providing a first NO₂ sensor response from both species of interest and interfering species (NO₂ and O₂) recorded on a computer-readable medium, the step 1106 exciting the NO₂ sensor at a second frequency providing a second NO₂ sensor response recorded on a computer-readable medium, the step 1108 using said second NO sensor response at said second frequency from both species of interest and interfering species (NO₂ and O₂) and the calibration information to produce a calculated concentration of the interfering parameters O₂ recorded on a computer-readable medium, and the step 1110 using said first NO₂ sensor response at said first frequency, said calculated concentration of the interfering parameters O₂, and the calibration information to measure the parameter of interest NO₂.

### Sensing Method for Measuring NO in a Background Varying O₂

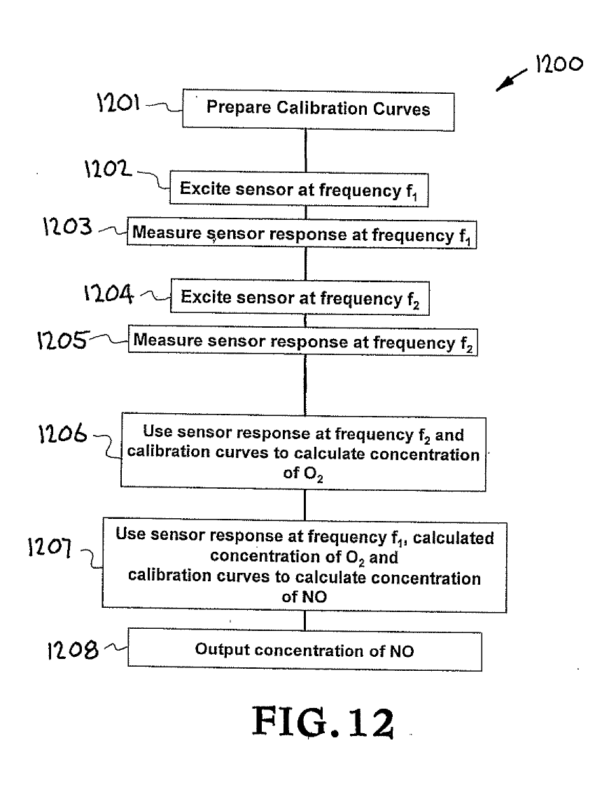

Referring now to FIG. 12, an embodiment of a sensing method for measuring NO in a background with varying O₂ concentration is illustrated. This embodiment of the present invention is designated generally by the reference numeral 1200. The method 1200 includes the steps of exciting the sensor at a first frequency producing a first frequency sensor response, measuring the first frequency sensor response producing a first frequency sensor measurement, exciting the sensor at a second frequency producing a second frequency sensor response, measuring the second frequency sensor response producing a second frequency sensor measurement, using the second frequency sensor measurement and the calibration information to produce a calculated concentration of O₂ measurement, and using the first frequency sensor measurement, the calculated concentration of O₂ measurement, and the calibration information to measure NO.

The method 1200 is an embodiment of the multiple frequency method for the operation of a NO sensor trying to measure the concentration of NO in a background with varying O₂ concentration. The actual sensing element is designed so that the relative sensitivities to NO and O₂ are different at two different frequencies—f₁ and f₂. The method 1200 includes the following steps: Step 1201 is to generate calibration curves. Step 1201 is performed prior to NO sensor operation. Step 1202 is to excite the NO sensor at frequency f₁. Response at f₁ contains contributions from both NO and O₂. Step 1203 is to measure NO sensor response at frequency f₁. Step 1204 is to excite the NO sensor at frequency f₂. Step 1205 is to measure NO sensor response at frequency f₂. Response at f₂ contains contributions only from O₂. Step 1206 is to use NO sensor response at frequency f₂and the calibration curves to calculate the concentration of interfering O₂. Step 1207 is to use NO sensor response at frequency f₁, calculated concentration of interfering O₂ and the calibration curves to calculate concentration of NO. Step 1208 provides output concentration of NO.

In summary, the method 1200 is sensing method to measure NO using calibration information wherein varying amount of O₂ may be present. The method 1200 includes the steps of exciting the sensor at a first frequency producing a first frequency sensor response that includes both NO and O₂, measuring the first frequency sensor response that includes both NO and O₂ producing a first frequency sensor measurement that includes both NO and O₂, exciting the sensor at a second frequency producing a second frequency sensor response that contains only O₂, measuring the second frequency sensor response producing a second frequency sensor measurement that contains only O₂, using the second frequency sensor measurement that contains only O₂ and the calibration information to produce a calculated concentration of O₂ measurement, and using the first frequency sensor measurement includes both NO and O₂, the calculated concentration of O₂ measurement, and the calibration information to measure NO.

### Sensing Method for Measuring CO in a Background Varying O₂

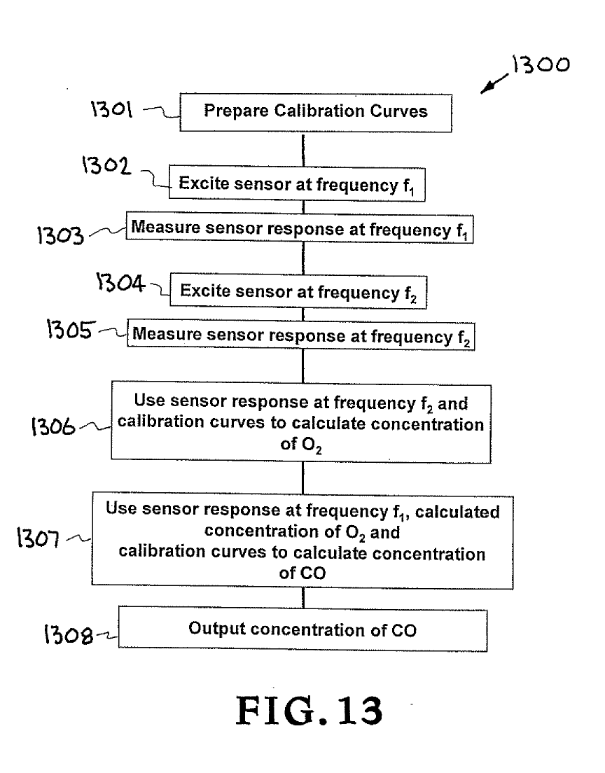

Referring now to FIG. 13, an embodiment of a sensing method for measuring CO in a background with varying O₂ concentration is illustrated. This embodiment of the present invention is designated generally by the reference numeral 1300. The method 1300 includes the steps of exciting the sensor at a first frequency producing a first frequency sensor response, measuring the first frequency sensor response producing a first frequency sensor measurement, exciting the sensor at a second frequency producing a second frequency sensor response, measuring the second frequency sensor response producing a second frequency sensor measurement, using the second frequency sensor measurement and the calibration information to produce a calculated concentration of O₂ measurement, and using the first frequency sensor measurement, the calculated concentration of O₂ measurement, and the calibration information to measure CO.

The method 1300 is an embodiment of the multiple frequency method for the operation of a CO sensor trying to measure the concentration of CO in a background with varying O₂ concentration. The actual sensing element is designed so that the relative sensitivities to CO and O₂ are different at two different frequencies—f₁ and f₂. The method 1300 includes the following steps: Step 1301 is to generate calibration curves. Step 1301 is performed prior to CO sensor operation. Step 1302 is to excite the CO sensor at frequency f₁. Response at f₁ contains contributions from both CO and O₂. Step 1303 is to measure CO sensor response at frequency f₁. Step 1304 is to excite the CO sensor at frequency f₂. Step 1305 is to measure CO sensor response at frequency f₂. Response at f₂ contains contributions only from O₂. Step 1306 is to use CO sensor response at frequency f₂and the calibration curves to calculate the concentration of interfering O₂. Step 1307 is to use CO sensor response at frequency f₁, calculated concentration of interfering O₂ and the calibration curves to calculate concentration of CO. Step 1308 provides output concentration of CO.

In summary, the method 1300 is a sensing method to measure CO using calibration information wherein varying amount of O₂ may be present. The method 1300 includes the steps of exciting the sensor at a first frequency producing a first frequency sensor response that includes both CO and O₂, measuring the first frequency sensor response that includes both CO and O₂ producing a first frequency sensor measurement that includes both CO and O₂, exciting the sensor at a second frequency producing a second frequency sensor response that contains only O₂, measuring the second frequency sensor response producing a second frequency sensor measurement that contains only O₂, using the second frequency sensor measurement that contains only O₂ and the calibration information to produce a calculated concentration of O₂ measurement, and using the first frequency sensor measurement includes both CO and O₂, the calculated concentration of O₂ measurement, and the calibration information to measure CO.

### Sensing Method for Measuring NO in a Background of Varying Temperature

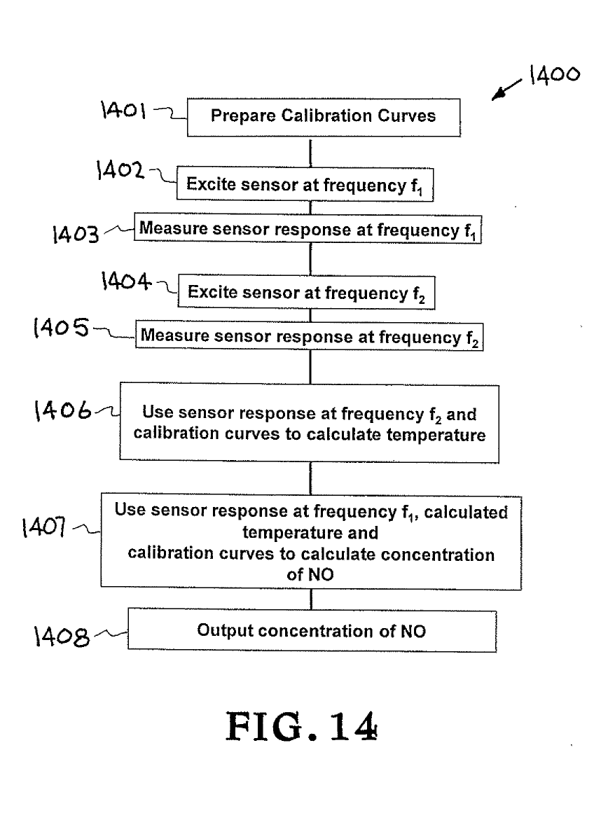

Referring now to FIG. 14, an embodiment of a sensing method for measuring NO in a background with varying temperature is illustrated. This embodiment of the present invention is designated generally by the reference numeral 1400. The method 1400 includes the steps of exciting the sensor at a first frequency producing a first frequency sensor response, measuring the first frequency sensor response producing a first frequency sensor measurement, exciting the sensor at a second frequency producing a second frequency sensor response, measuring the second frequency sensor response producing a second frequency sensor measurement, using the second frequency sensor measurement and the calibration information to produce a calculated temperature measurement, and using the first frequency sensor measurement, the calculated temperature measurement, and the calibration information to measure NO.

The method 1400 is an embodiment of the multiple frequency method for the operation of a NO sensor trying to measure the concentration of NO in a background with varying temperature. The actual sensing element is designed so that the relative sensitivities to NO and temperature are different at two different frequencies—f₁ and f₂. The method 1400 includes the following steps: Step 1401 is to generate calibration curves. Step 1401 is performed prior to NO sensor operation. Step 1402 is to excite the NO sensor at frequency f₁. Response at f₁ contains contributions from both NO and temperature. Step 1403 is to measure NO sensor response at frequency f₁. Step 1404 is to excite the NO sensor at frequency f₂. Step 1405 is to measure NO sensor response at frequency f₂. Response at f₂ contains contributions only from temperature. Step 1406 is to use NO sensor response at frequency f₂and the calibration curves to calculate temperature. Step 1407 is to use NO sensor response at frequency f₁, calculated temperature and the calibration curves to calculate concentration of NO. Step 1408 provides output concentration of NO.

In summary, the method 1400 is sensing method to measure NO using calibration information wherein varying temperature may be present. The method 1400 includes the steps of exciting the sensor at a first frequency producing a first frequency sensor response that includes both NO and temperature, measuring the first frequency sensor response that includes both NO and temperature producing a first frequency sensor measurement that includes both NO and temperature, exciting the sensor at a second frequency producing a second frequency sensor response that contains only temperature, measuring the second frequency sensor response producing a second frequency sensor measurement that contains only temperature, using the second frequency sensor measurement that contains only temperature and the calibration information to produce a calculated temperature measurement, and using the first frequency sensor measurement includes both NO and temperature, the calculated temperature measurement, and the calibration information to measure NO.

### Sensing Method for Measuring NO₂ in a Background Varying O₂

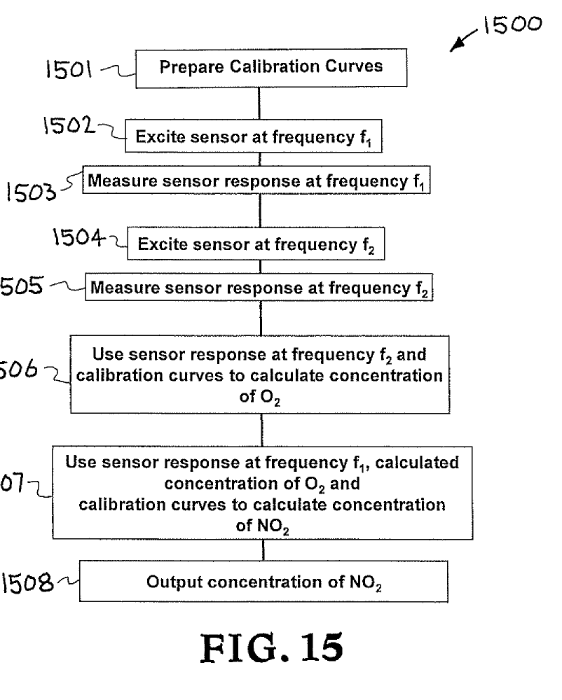

Referring now to FIG. 15, an embodiment of a sensing method for measuring NO₂ in a background with varying O₂ concentration is illustrated. This embodiment of the present invention is designated generally by the reference numeral 1500. The method 1500 includes the steps of exciting the sensor at a first frequency producing a first frequency sensor response, measuring the first frequency sensor response producing a first frequency sensor measurement, exciting the sensor at a second frequency producing a second frequency sensor response, measuring the second frequency sensor response producing a second frequency sensor measurement, using the second frequency sensor measurement and the calibration information to produce a calculated concentration of O₂ measurement, and using the first frequency sensor measurement, the calculated concentration of O₂ measurement, and the calibration information to measure NO₂.

The method 1500 is an embodiment of the multiple frequency method for the operation of a NO₂ sensor trying to measure the concentration of NO₂ in a background with varying O₂ concentration. The actual sensing element is designed so that the relative sensitivities to NO₂ and O₂ are different at two different frequencies—f₁ and f₂. The method 1500 includes the following steps: Step 1501 is to generate calibration curves Steps is performed prior to NO₂ sensor operation. Step 1502 is to excite the NO₂ sensor at frequency f₁. Response at f₁ contains contributions from both NO₂ and O₂. Step 1503 is to measure NO₂ sensor response at frequency f₁. Step 1504 is to excite the NO₂ sensor at frequency f₂. Step 1505 is to measure NO₂ sensor response at frequency f₂. Response at f₂ contains contributions only from O₂. Step 1506 is to use NO₂ sensor response at frequency f₂ and the calibration curves to calculate the concentration of interfering O₂. Step 1507 is to use NO₂ sensor response at frequency f₁, calculated concentration of interfering O₂ and the calibration curves to calculate concentration of NO₂. Step 1508 provides output concentration of NO₂.

In summary, the method 1500 is sensing method to measure NO₂ using calibration information wherein varying amount of O₂ may be present. The method 1500 includes the steps of exciting the sensor at a first frequency producing a first frequency sensor response that includes both NO₂ and O₂, measuring the first frequency sensor response that includes both NO₂ and O₂ producing a first frequency sensor measurement that includes both NO₂ and O₂, exciting the sensor at a second frequency producing a second frequency sensor response that contains only O₂, measuring the second frequency sensor response producing a second frequency sensor measurement that contains only O₂, using the second frequency sensor measurement that contains only O₂ and the calibration information to produce a calculated concentration of O₂ measurement, and using the first frequency sensor measurement includes both NO₂ and O₂, the calculated concentration of O₂ measurement, and the calibration information to measure NO₂.

### Electrochemical Sensors for Monitoring Emissions

Increasingly stringent emissions regulations require the development of advanced gas sensors for a variety of applications. For example, compact, inexpensive sensors are needed for detection of regulated pollutants, including hydrocarbons (HCs), CO, and NOx, in automotive exhaust. Of particular importance will be a sensor for NOx to ensure the proper operation of the catalyst system in the next generation of diesel (CIDI) automobiles. Compact, inexpensive sensors are particularly in demand for monitoring and control of regulated pollutants including hydrocarbons, carbon monoxide, and oxides of nitrogen (NOx).

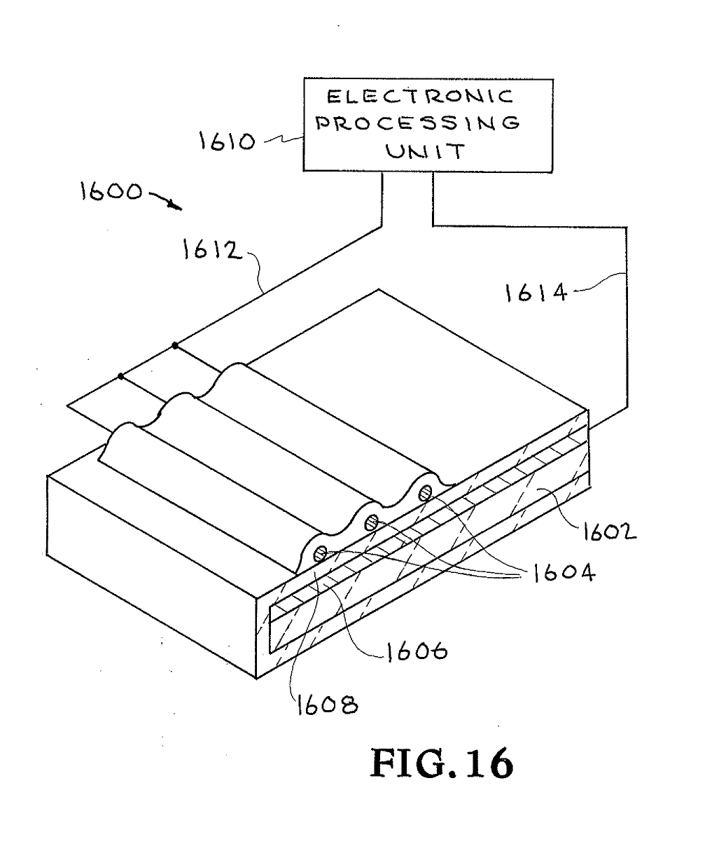

Referring now to FIG. 16, an embodiment of a sensor system for monitoring emissions is illustrated. The sensor system is designated generally by the reference numeral 1600. The sensor system 1600 includes an alumina substrate 1602 and a first electrode 1604. The first electrode 1604 is made of a dense electrode material. As used in this application, the term “dense electrode material” means any electronically conducting material (i.e., metal or ceramic oxide) that acts as an electrode in the electrochemical cell and has a density of more than 95% of theoretical density.

In the embodiment illustrated in FIG. 16 the first electrode is made of the dense electrode material gold 1604. In other embodiments the first electrode 1604 is made of other dense electrode materials. A platinum layer 1606 on the alumina substrate 1602 forms a second electrode. A porous electrolyte material 1608 is located between the first electrode 1602 and the second electrode 1606. The porous electrolyte material 1608 illustrated in FIG. 16 is yttria-stabilized zirconia which is an oxygen-ion conducting ceramic. In other embodiments the porous electrolyte material 1608 is made of other oxygen-ion conductors and can be made of any ion-conductor acting as an electrolyte. An electronic processing unit 1610 is connected to the first electrode by lead(s) 1612 and is connected to the second electrode 1606 by lead 1614

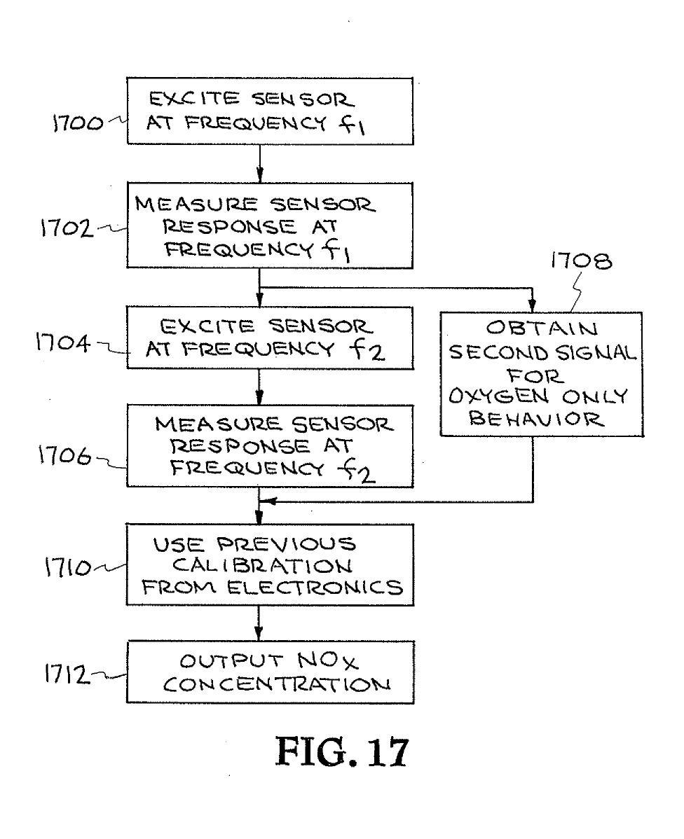

Referring now to FIG. 17, the operation of the sensor system will be illustrated. FIG. 17 is a flow chart that show various steps involved in the operation of the sensor system. In step #1, designated by the reference numeral 1700, one sensor is excited at a frequency f₁. In step #2, designated by the reference numeral 1702, the sensor response is measured at frequency f₁.

FIG. 17 shows alternatives for steps #3 and #4. In the first alternative, step #3, designated by the reference numeral 1704 is that another sensor is excited at a frequency f₂. In step #4, designated by the reference numeral 1706, the other sensor response is measured at frequency f₂. In the second alternative, step #3 and step #4 are designated by the reference numeral 1708 which is to obtain a second signal for oxygen-only behavior.

In step #5, designated by the reference numeral 1710, is to use previous calibration from the electronic processing unit. In step #6, designated by the reference numeral 1712, the output of NOx concentration is provided.

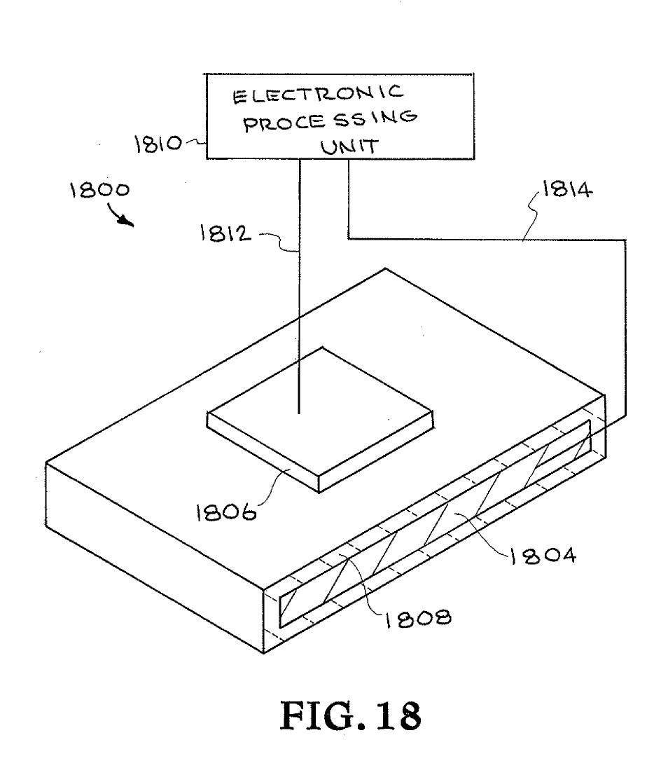

Referring now to FIG. 18, another embodiment of a sensor system for monitoring emissions is illustrated. The sensor system shown in FIG. 18 is designated generally by the reference numeral 1800. The sensor system 1800 includes a first electrode 1804. The first electrode 1804 is made of a dense electrode material. In this embodiment the first electrode 1804 is made of the dense electrode material LSM (La_{0.85}Sr_{0.15}MnO₃), an electronically conducting oxide. In this embodiment the second electrode 1806 is made of porous LSM. A porous electrolyte material 1808 is located between the first electrode 1804 and the second electrode 1804. The porous electrolyte material 1808 illustrated in FIG. 18 is yttria-stabilized zirconia which is an oxygen-ion conducting ceramic. In other embodiments the porous electrolyte material 1808 is made of other oxygen-ion conductors and can be made of any ion-conductor acting as an electrolyte. An electronic processing unit 1810 is connected to the first electrode 1804 by lead 1814 and is connected to the second electrode 1806 by lead 1812.

The structural elements of the sensor system 1800 having been described, the operation of the sensor system 1800 will now be described. The operation of the sensor system 1800 involves various steps. In step #1, one of the sensors is excited at a frequency f₁. In step #2, the sensor response is measured at frequency f₁. The next step actually involves alternatives steps #3 and #4. In the first alternative, step #3, the other sensor is excited at a frequency f₂. In step #4, the other sensor response is measured at frequency f₂. In the second alternative, step #3 and step #4 is to obtain a second signal for oxygen-only behavior. Step #5, is to use previous calibration from the electronic processing unit 1810. In step #6, the output of NOx concentration is provided by the processing unit 1810.

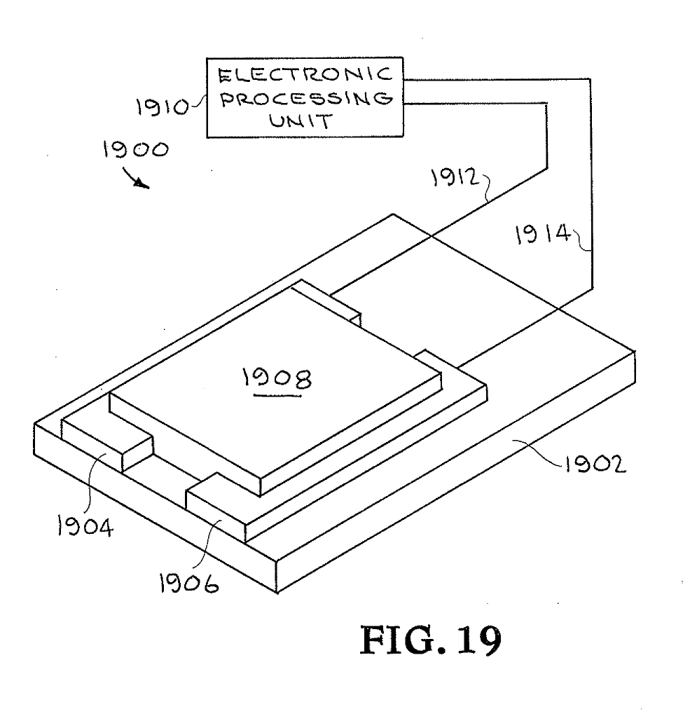

Referring now to FIG. 19, another embodiment of a sensor system for monitoring emissions is illustrated. The sensor system shown in FIG. 19 is designated generally by the reference numeral 1900. The sensor system 1900 includes an alumina substrate 1902. In the embodiment illustrated in FIG. 19 the alumina substrate 1902 is a heated alumina substrate. A first electrode 1904 is deposited on the alumina substrate 1902. The first electrode 1904 is made of a dense electrode material. In this embodiment the first electrode 1904 is made of the dense electrode material LSM (La_{0.85}Sr_{0.15}MnO₃), an electronically conducting oxide. A second electrode 1904 is deposited on the alumina substrate 1902. In this embodiment the second electrode 1906 is made of the dense electrode material LSM (La_{0.85}Sr_{0.15}MnO₃), an electronically conducting oxide.

A porous electrolyte material 1908 is located between the first electrode 1904 and the second electrode 1904. The porous electrolyte material 1908 illustrated in FIG. 19 is yttria-stabilized zirconia which is an oxygen-ion conducting ceramic. In other embodiments the porous electrolyte material 1908 is made of other oxygen-ion conductors and can be made of any ion-conductor acting as an electrolyte. An electronic processing unit 1910 is connected to the first electrode 1904 by lead 1914 and is connected to the second electrode 1906 by lead 1912.

The structural elements of the sensor system 1900 having been described, the operation of the sensor system 1900 will now be described. The operation of the sensor system 1900 involves various steps. In step #1, one of the sensors is excited at a frequency f₁. In step #2, the sensor response is measured at frequency f₁. The next step actually involves alternatives steps #3 and #4. In the first alternative, step #3, the other sensor is excited at a frequency f₂. In step #4, the other sensor response is measured at frequency f₂. In the second alternative, step #3 and step #4 is to obtain a second signal for oxygen-only behavior. Step #5, is to use previous calibration from the electronic processing unit 1910. In step #6, the output of NOx concentration is provided by the processing unit 1910.

### Operation of Electrochemical Sensors for Monitoring Emissions

The sensor system is operated by applying a varying (typically sinusoidal) voltage difference between the two electrodes. The excitation signal is chosen at a fixed frequency, for example 10 Hz. A phase meter, phase lock loop, or other electronic measuring circuit is used to measure the changes in amplitude and phase of the excitation signal, after it interacts with the sensor, relative to a fixed, reference signal of the same frequency.

Applicants have demonstrated the effective use of a circuit board, which was configured to apply the alternating signal and then output the in-phase (conductive) and out-of-phase (capacitive) portions of the sensor response, for operation of the sensor. The amplitude of the response, which can be correlated with the impedance |Z|, is sensitive to the changes which the sensor is trying to detect (for example the NOx concentration in an exhaust gas), has been reported as a sensing metric at low frequency (1 Hz). However, Applicants' observation, is that the phase angle signal is a better metric of the sensor response. The phase is more stable, responds more quickly, and maintains the response to higher frequency than |Z|. Also, Applicants' work has determined compositional and microstructural criteria for the sensing electrode materials to optimize the sensor for sensitivity to ppm NOx in a large background of O2, which can be modified and extended for sensing other types of gases and for use in other types of electrochemical cells.

The sensing electrode is defined by its ability to change polarization when the desired concentration of the sensing gas to be detected is introduced. In general, the sensing gas and other gases present that may cause undesired cross-sensitivity can have parallel kinetic contributions on the resulting polarization of the sensing electrode depending on its catalytic behavior. Due to the parallel kinetic contributions, relatively small amounts of the sensing gas can be detected in a background of competing gas of much larger concentrations for a sensing electrode with an appropriately low catalytic activity towards the competing gas of much larger concentration. For sensing ppm NOx in percent levels of oxygen, the above criteria have been shown to be met using porous yttria-stabilized zirconia as the electrolyte, and dense gold as symmetric electrodes. (See attached journal articles for more details.) The sensing behavior is not limited to gold electrodes, or to symmetric electrodes, and we have demonstrated sensing using materials and compositions with the appropriate catalytic activities, including dense electronically conducting perovskites.

Another aspect of the proposed invention is the issue of the frequency of operation. Sensitivity is typically higher at lower frequencies, which is why the work of Miura reports sensing at 1 Hz; due to a combination of their sensor properties and their measurement of |Z| rather than phase angle, they cannot operate at higher frequencies while maintaining sufficient sensitivity. However, since the frequency determines response and sampling times (with 1/frequency representing a general limitation for the sampling rate), it is probably not practical to operate below ˜5 Hz, and desirable to operate at the highest frequency at which sufficient sensitivity can be obtained. At much higher frequencies, however, such as 1000 Hz or more, the sensor has no response to (in our case) NOx but responds only to changes in the O2 background, temperature, and other interfering effects. This provides another point of novelty in the proposed sensor, that the sensor can be simultaneously operated at two (or more) widely different frequencies to provide a compensation for these interfering effects. That is, for example, at 10 Hz the sensor senses both changes in the concentrations of NOx and O2, while at 1000 Hz it senses only the changes in O2. Thus, by comparing these signals the competing effects of variations of several percent in the O2 background can be deconvolved from the effects of ppm changes in the NOx concentration.

The design and operation of the sensor system uses the response to alternating current excitation as the sensing signal, also known as impedancemetric operation, and consists of a porous electrolyte material and dense electrode material(s). In one embodiment the porous electrolyte is yttria-stabilized zirconia. The porous electrolyte is not limited to yttria-stabilized zirconia, or even to oxygen-ion conductors, but could be any ion-conductor acting as an electrolyte.

In the design and operation of the sensor system the porous electrolyte is either fabricated using graphitic pore formers and fired to temperatures greater than 1500° C., or fabricated using a ceramic powder slurry containing binders and/or plasticizers and fired to temperature greater than 900° C., but less than 1500° C. The green porous electrolyte can be processed prior to firing using tape-cast methods or direct application methods such as painting or spraying.

In one embodiment of the design and operation of the sensor system both electrodes in contact with the electrolyte are exposed to the same gas composition (i.e., the sensing gas) or only one electrode is exposed to the sensing gas, and the other electrode is in a reference gas composition (e.g., air). In another embodiment of the design and operation of the sensor system both electrodes are different but both act as sensing electrodes, or where both electrodes are different and only one electrode serves as the sensing electrode while the other electrode serves primarily as a counter electrode. The sensing electrode is defined by its ability to change polarization when the desired concentration of the sensing gas to be detected is introduced. The counter electrode is defined by the relative insensitivity of its polarization to changes in the concentration of the sensing gas. In general, the sensing gas and other gases present that may cause undesired cross-sensitivity can have parallel kinetic contributions on the resulting polarization of the sensing electrode depending on its catalytic behavior. Due to the parallel kinetic contributions, relatively small amounts of the sensing gas can be detected in a background of competing gas of much larger concentrations for a sensing electrode with an appropriately low catalytic activity towards the competing gas of much larger concentration.

In one embodiment of the design and operation of the sensor system the sensing electrode has a dense microstructure and material composition that has low catalytic activity towards oxygen. In another embodiment of the design and operation of the sensor system the counter electrode has relatively high catalytic activity towards oxygen.

In one embodiment of the design and operation of the sensor system the frequency of the applied low-amplitude alternating current excitation ranges from 1 to 1000 Hz. The frequency of operation is chosen based on maximizing sensitivity while reducing sampling time. The specific type of reactions (diffusion, adsorption, charge-transfer) occurring on both electrodes and the specific type of species (neutral, ionized) present will alter the optimum frequency of operation. Controlling the specific behavior can be achieved by altering the composition, microstructure, and geometry of the electrodes. For sensing ppm NOₓ in a background of 2 to 20% O₂, the sensing electrode should have a composition with low catalytic activity towards oxygen and a dense microstructure, which then allows optimum performance at frequencies near 10 Hz.

In one embodiment of the design and operation of the sensor system the temperature of operation is chosen to reduce cross-sensitivity to interfering species (e.g., water vapor) and optimize the sensor sensitivity and accuracy. In another embodiment of the design and operation of the sensor system an oxidation catalyst located upstream of the operating sensor is used to control the resulting gas composition in order to reduce cross-sensitivity to interfering species (e.g., NO₂ and NH₃) and optimize the sensor sensitivity and accuracy.

In one embodiment of the design and operation of the sensor system the sensing electrode is dense gold and the counter electrode is porous platinum. In one embodiment of the design and operation of the sensor system the frequency of operation is 10 Hz and the temperature of operation is 650° C. In one embodiment of the design and operation of the sensor system the sensing electrode is dense gold that is covered by a thin layer of porous YSZ electrolyte material, less than about 50 micron layer, to provide identical responses to either NO or NO₂. The identical response could be due to the larger thickness layers of YSZ, greater than about 50 microns, providing additional reaction sites for the NO₂ species and therefore producing a larger, and unequal, signal when responding to NO₂ compared to NO.

In one embodiment of the design and operation of the sensor system the sensing electrode is dense strontium-doped lanthanum manganite and the counter electrode is porous platinum. The frequency of operation is 10 Hz and the temperature of operation is 575° C. In another embodiment of the design and operation of the sensor system the sensing electrode is dense strontium-doped lanthanum chromite and the counter electrode is porous platinum. The frequency of operation is 10 Hz and the temperature of operation is 575° C. In another embodiment of the design and operation of the sensor system the sensing electrode is dense magnesium-doped lanthanum chromite and the counter electrode is porous platinum. The frequency of operation is 10 Hz and the temperature of operation is 575° C. In another embodiment of the design and operation of the sensor system the sensing electrode is dense strontium-doped lanthanum manganite and the counter electrode is porous strontium-doped lanthanum manganite. The frequency of operation is 10 Hz and the temperature of operation is 575° C.

In one embodiment of the design and operation of the sensor system the sensing electrode is a dense electronically conducting oxide or an inert metal (e.g., gold) or an electronically conducting material coated with either a dense electronically conducting oxide or an inert metal and the counter electrode is also a sensing electrode of similar or different composition as the other sensing electrode, or a porous electronically oxide of the same or different composition than the sensing electrode, or a porous layer of metal. The frequency of operation is between 1 and 1000 Hz, and chosen based on maximizing sensitivity while reducing sampling time. The temperature of operation is between 400° C. and 800° C., and chosen to reduce cross-sensitivity to interfering species and optimize the sensor sensitivity and accuracy.

In one embodiment of the design and operation of the sensor system both electrodes are co-located on the same surface of the sensor allowing the bottom non-active surface to be mounted onto a separate device such as a heated substrate. In one embodiment of the design and operation of the sensor system a circuit board is configured to apply the alternating signal and then output the in-phase (conductive) and out-of-phase (capacitive) portions of the sensor response.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An electrochemical sensor apparatus for monitoring emissions, comprising:
first and second electrodes, wherein at least one of said first and second electrodes is made of a dense electrode material;
a porous electrolyte material operatively connected to said first and second electrodes, wherein said porous electrolyte material is made of ion-conductor material that acts as an electrolyte; and
an electronic processing unit operatively to said first and second electrodes that excites said first electrode at a frequency f₁ and receives a response from said first electrode at frequency f₁, said electronic processing unit obtaining a second signal base on the emissions and said electronic processing unit producing a response indicating the emissions.

2. The electrochemical sensor apparatus for monitoring emissions of claim 1 wherein said electronic processing unit operatively to said first and second electrodes that obtains a second signal base on the emissions comprises an electronic processing unit that excites said second electrode at a frequency f₂ and receives a response from said second electrode at frequency f₂.

3. The electrochemical sensor apparatus for monitoring emissions of claim 1 wherein at least one of said first and second electrodes is made of gold.

4. The electrochemical sensor apparatus for monitoring emissions of claim 1 wherein at least one of said first and second electrodes is made of an electronically conducting oxide.

5. The electrochemical sensor apparatus for monitoring emissions of claim 1 wherein at least one of said first and second electrodes is made of LSM (La_{0.85}Sr_{0.15}MnO₃).

6. The electrochemical sensor apparatus for monitoring emissions of claim 1 wherein said porous electrolyte material operatively connected to said first and second electrodes is an ion-conductor acting as an electrolyte.

7. The electrochemical sensor apparatus for monitoring emissions of claim 1 wherein said porous electrolyte material operatively connected to said first and second electrodes is an oxygen-ion conductor.

8. The electrochemical sensor apparatus for monitoring emissions of claim 1 wherein said porous electrolyte material operatively connected to said first and second electrodes is an oxygen-ion conducting ceramic.

9. The electrochemical sensor apparatus for monitoring emissions of claim 1 wherein said porous electrolyte material operatively connected to said first and second electrodes is yttria-stabilized zirconia.

10. The electrochemical sensor apparatus for monitoring emissions of claim 1 including an alumina substrate operatively connected to at least one of said electrodes.

11. An electrochemical sensor apparatus for monitoring vehicle emissions, comprising:
a first electrode,
a second electrodes, wherein at least one of said first and second electrodes is made of a dense electrode material;
a porous electrolyte material operatively connected to said first and second electrodes, wherein said porous electrolyte material is made of ion-conductor material that acts as an electrolyte; and
an electronic processing unit operatively to said first and second electrodes that excites said first electrode at a frequency f₁ and receives a response from said first electrode at frequency f₁, said electronic processing unit obtaining a second signal base on the vehicle emissions and said electronic processing unit producing an output indicating the vehicle emissions.

12. The electrochemical sensor apparatus for monitoring vehicle emissions of claim 11 wherein said electronic processing unit operatively to said first and second electrodes that obtains a second signal base on the vehicle emissions comprises an electronic processing unit that excites said second electrode at a frequency f₂ and receives a response from said second electrode at frequency f₂.

13. The electrochemical sensor apparatus for monitoring vehicle emissions of claim 11 wherein at least one of said first and second electrodes is made of gold.

14. The electrochemical sensor apparatus for monitoring vehicle emissions of claim 11 wherein at least one of said first and second electrodes is made of an electronically conducting oxide.

15. The electrochemical sensor apparatus for monitoring vehicle emissions of claim 11 wherein at least one of said first and second electrodes is made of LSM (La_{0.85}Sr_{0.15}MnO₃).

16. The electrochemical sensor apparatus for monitoring vehicle emissions of claim 11 wherein said porous electrolyte material operatively connected to said first and second electrodes is an ion-conductor acting as an electrolyte.

17. The electrochemical sensor apparatus for monitoring vehicle emissions of claim 11 wherein said porous electrolyte material operatively connected to said first and second electrodes is an oxygen-ion conductor.

18. The electrochemical sensor apparatus for monitoring vehicle emissions of claim 11 wherein said porous electrolyte material operatively connected to said first and second electrodes is an oxygen-ion conducting ceramic.

19. The electrochemical sensor apparatus for monitoring vehicle emissions of claim 11 wherein said porous electrolyte material operatively connected to said first and second electrodes is yttria-stabilized zirconia.

20. The electrochemical sensor apparatus for monitoring vehicle emissions of claim 11 including an alumina substrate operatively connected to at least one of said electrodes.

21. A electrochemical sensor method for monitoring emissions, comprising the steps of:
locating first and second electrodes in a position to sense the emissions, wherein at least one of said first and second electrodes is made of a dense electrode material;
locating a porous electrolyte material operatively connected to said first and second electrodes, wherein said porous electrolyte material is made of ion-conductor material that acts as an electrolyte;
exciting said first electrode at a frequency f₁,
receiving a response from said first electrode at frequency f₁,
obtaining a second signal base on the emissions, and
producing a response indicating the emissions.

22. The electrochemical sensor method of claim 21 wherein said step of obtaining a second signal base on the emissions comprises exciting said second electrode at a frequency f₂ and receiving a response from said second electrode at frequency f₂.

23. The electrochemical sensor method of claim 21 wherein said step of obtaining a second signal base on the emissions comprises obtaining a second signal for reference.

24. A electrochemical sensor method for monitoring emissions, comprising the steps of:
locating a first electrode made of a dense electrode material in a position to sense the emissions and provide a first signal;
locating a second electrode in a position to obtain a second signal;
locating a porous electrolyte material made of ion-conductor material that acts as an electrolyte operatively connected to said first and second electrodes;
exciting said first electrode at a frequency f₁,
receiving a response from said first electrode at frequency f₁,
obtaining a second signal base on the emissions, and
producing a response indicating the emissions.

25. The electrochemical sensor method of claim 24 wherein said step of locating a first electrode made of a dense electrode material in a position to sense the emissions and provide a first signal comprises locating a first electrode made of gold in a position to sense the emissions and provide a first signal.

26. The electrochemical sensor method of claim 24 wherein said step of locating a first electrode made of a dense electrode material in a position to sense the emissions and provide a first signal comprises locating a first electrode made of an electronically conducting oxide in a position to sense the emissions and provide a first signal.

27. The electrochemical sensor method of claim 24 wherein said step of locating a first electrode made of a dense electrode material in a position to sense the emissions and provide a first signal comprises locating a first electrode made of LSM (La_{0.85}Sr_{0.15}MnO₃) in a position to sense the emissions and provide a first signal.

28. The electrochemical sensor method of claim 24 wherein said step of locating a porous electrolyte material made of ion-conductor material that acts as an electrolyte operatively connected to said first and second electrodes comprises locating a porous electrolyte material made of oxygen-ion conductor material that acts as an electrolyte operatively connected to said first and second electrodes.

29. The electrochemical sensor method of claim 24 wherein said step of locating a porous electrolyte material made of ion-conductor material that acts as an electrolyte operatively connected to said first and second electrodes comprises locating a porous electrolyte material made of oxygen-ion conducting ceramic material that acts as an electrolyte operatively connected to said first and second electrodes.

30. The electrochemical sensor method of claim 24 wherein said step of locating a porous electrolyte material made of ion-conductor material that acts as an electrolyte operatively connected to said first and second electrodes comprises locating a porous electrolyte material made of yttria-stabilized zirconia material that acts as an electrolyte operatively connected to said first and second electrodes.
